(19) United States
(12) Patent Application Publication
(10) Pub. No.: US 2013/0336343 A1
(43) Pub. Date: Dec. 19, 2013

(54) OPTICAL FIBER, OPTICAL FIBER LASER AND OPTICAL FIBER AMPLIFIER, AND METHOD OF MANUFACTURING OPTICAL FIBER

(71) Applicant: Furukawa Electric Co., Ltd., Tokyo (JP)

(72) Inventors: Ryo MIYABE, Tokyo (JP); Keiichi Aiso, Tokyo (JP)

(73) Assignee: Furukawa Electric Co., Ltd., Tokyo (JP)

(21) Appl. No.: 13/973,051

(22) Filed: Aug. 22, 2013

Related U.S. Application Data
(63) Continuation of application No. PCT/JP2012/067913, filed on Jul. 13, 2012.

(30) Foreign Application Priority Data
Sep. 12, 2011 (JP) 2011-198817

(51) Int. Cl. H01S 3/067; G02B 6/036

(52) U.S. Cl. CPC H01S 3/06716; G02B 6/03633; H01S 3/06754
USPC 372/6; 385/127; 359/341.1; 427/163.2

(57) ABSTRACT

An optical fiber has: a core made of silica glass in which a rare earth element and aluminum have been added; an inner cladding layer that is formed around the core, is made of silica glass in which at least any one of an alkali metal and an alkali earth metal has been added, and has a refractive index lower than a refractive index of the core; and an outer cladding layer that is formed around the inner cladding layer and has a refractive index lower than the refractive index of the inner cladding layer.

### CROSS-REFERENCE TO RELATED APPLICATIONS

This application is a continuation of PCT International Application No. PCT/JP2012/067913 filed on Jul. 13, 2012, which claims the benefit of priority from Japanese Patent Application No. 2011-198817 filed on Sep. 12, 2011. The entire contents of this PCT international application and this Japanese patent application are incorporated herein by reference.

### BACKGROUND OF THE INVENTION

1. Field of the Invention

The present invention relates to: an optical fiber having a core doped with a rare earth element and aluminum; an optical fiber laser and an optical fiber amplifier that use the optical fiber; and a method of manufacturing an optical fiber having a core doped with a rare earth element and aluminum.

2. Description of the Related Art

Recently, optical fiber lasers having, as amplifying media, optical fibers having cores doped with rare earth elements have drawn attention and started to be practically applied in various fields such as metal processing and medical fields. There are optical fiber lasers using various rare earth elements such as ytterbium (Yb), erbium (Er), and thulium (Tm), and among them, an optical fiber laser with a wavelength bandwidth of 1 μm using a silica glass optical fiber doped with Yb (ytterbium doped optical fiber: YDF) is known for its capability of laser emission at high output and high efficiency. Moreover, one of factors for its active development is that the optical fiber laser using the YDF has the emission wavelength bandwidth which is the same as that of a YAG laser or a semiconductor laser that have been widely used as a high-output laser.

One reason for the capability of high output by the optical fiber laser using the YDF is its capability of highly efficient optical amplification due to its possibility of being added with several mass % (wt %) of Yb in its core because Yb³⁺ ions are unlikely to cause concentration quenching even if a doping concentration of Yb³⁺ ions is made higher than that of, for example, Er³⁺ ions. Further, by using the YDF with a double clad structure in a double clad type optical fiber laser, even higher output becomes possible. “Double clad structure” means a structure in which an inner cladding layer and an outer cladding layer are sequentially formed around the core. In the double clad type optical fiber laser, laser light is confined in the core and propagated therein, and pumping light is confined in the core and the inner cladding layer and propagated therein.

However, it is known that, in optical fibers doped with various rare earth elements, when pumping light of a high intensity is input into their cores, a loss increase phenomenon called “photodarkening” occurs (M. M. Broer et al., “Highly nonlinear near-resonant photodarkening in a thulium-added aluminosilicate glass fiber” Opt. Lett. Vol. 18, pp. 799-801 (1993)).

In particular, in the YDF, as the doping concentration of Yb becomes higher, transmission loss in an ultraviolet light region is drastically increased due to the “photodarkening” phenomenon. Due to this influence, transmission loss is also increased in a wavelength bandwidth of 1 μm that is an emission wavelength bandwidth. Furthermore, since this transmission loss is increased over time by input of pumping light, when forming an optical fiber therewith, output intensity of laser light attenuates over time (J. J. Koponen et al., “Measuring photodarkening from single-mode ytterbium added silica fibers” Opt. Express vol. 14 pp. 11539-11544 (2006). and J. J. Koponen et al., “Photodarkening in ytterbium-added silica fibers”, [online], September 2005, [referenced on Sep. 8, 2011], internet <URL: http://www.nlight.net/nlight-files/file/technical_papers/SecDef05_Photodarkening . . . pdf>). As means for suppressing this “photodarkening” phenomenon, a method of reducing the increase in the transmission loss by coadding aluminum (Al) when manufacturing a core preform doped with Yb to suppress clustering of the Yb³⁺ ions has been reported (Japanese Patent No. 3475109 and T. Kitabayashi et al., “Population Inversion Factor Dependence of Photodarkening of Yb-added Fibers and its Suppression by Highly Aluminum Adding” OFC2005, paper OThC5 (2005)).

When manufacturing an optical fiber of a double clad structure, for example, a method of inserting a core preform to become a core into a glass tube (a jacket tube) for forming an inner cladding layer, and heating and integrating both of them is used. Alternatively, there is a method of, after forming a porous layer by depositing fine particles made of silica glass on a core preform, vitrifying the porous layer by heating to form a layer to be an inner cladding layer.

However, a softening temperature of the core preform coadded with Yb and Al is decreased in proportion to a doping concentration of Al. Moreover, a viscosity of the core preform coadded with Yb and Al becomes lower than a viscosity of a core preform made of pure silica glass not added with them. Therefore, in a process of manufacturing the optical fiber preform or the optical fiber, a crack is generated at an interface between the core preform and the inner cladding layer (the inner cladding layer in the optical fiber preform, hereinafter, referred to as a “preform inner cladding layer” as appropriate) that is formed around the core preform, and manufacture of the optical fiber preform may become difficult, thereby reducing productivity of the optical fiber. In addition, there has been a problem that a strain remains between the core and the inner cladding layer of the manufactured optical fiber, which may increase the transmission loss and lead to failure of obtaining desired optical characteristics.

Accordingly, there is a need to provide: an optical fiber that is able to achieve desired optical characteristics with high productivity; an optical fiber laser and an optical fiber amplifier using the optical fiber; and a method of manufacturing an optical fiber by which optical fibers having desired optical characteristics are able to be manufactured with high productivity.

### SUMMARY OF THE INVENTION

According to an aspect of the present invention, an optical fiber includes: a core made of silica glass in which a rare earth element and aluminum have been added; an inner cladding layer that is formed around the core, is made of silica glass in which at least any one of an alkali metal and an alkali earth metal has been added, and has a refractive index lower than a refractive index of the core; and an outer cladding layer that is formed around the inner cladding layer and has a refractive index lower than the refractive index of the inner cladding layer.

Further, according to another aspect of the present invention, an optical fiber laser includes the optical fiber as an amplifying optical fiber.

Further, according to yet another aspect of the present invention, an optical fiber amplifier includes the optical fiber as an amplifying optical fiber.

Further, according to still another aspect of the present invention, a method of manufacturing an optical fiber includes: inserting a core preform made of silica glass in which a rare earth element and aluminum have been added, into an inner-cladding-layer-forming glass tube that is made of silica glass in which at least any one of an alkali metal and an alkali earth metal has been added and has a refractive index lower than a refractive index of the core preform; and heating and integrating the core preform and the inner-cladding-layer-forming glass tube.

Further, according to yet another aspect of the present invention, a method of manufacturing an optical fiber includes: forming a porous layer by depositing silica glass fine particles around a core preform made of silica glass in which a rare earth element and aluminum have been added; adding at least any one of an alkali metal and an alkali earth metal into the porous layer; and heating and vitrifying the porous layer that has been doped with the at least any one of an alkali metal and an alkali earth metal.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a view illustrating a schematic cross-section of an optical fiber according to a first embodiment and a refractive index profile thereof;

FIG. 2 is a schematic block diagram of an optical fiber laser according to a second embodiment; and

FIG. 3 is a schematic view of an output spectrum of the optical fiber laser.

### DETAILED DESCRIPTION OF THE PREFERRED EMBODIMENTS

Hereinafter, embodiments of an optical fiber, an optical fiber laser and an optical fiber amplifier and a method for manufacturing the optical fiber according to the present invention will be described in detail with reference to the accompanying drawings. However, the present invention is not limited by these embodiments.

### First Embodiment

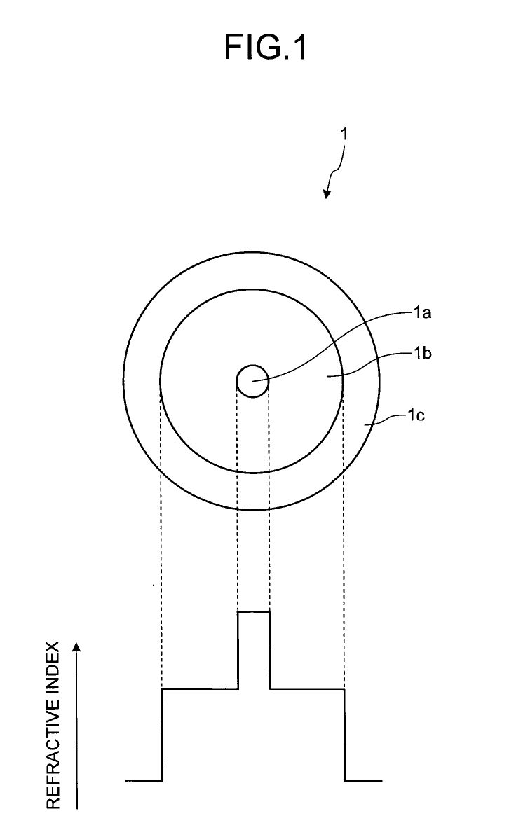

FIG. 1 is a view illustrating a schematic cross-section of an optical fiber according to a first embodiment of the present invention and a refractive index profile thereof. As illustrated in FIG. 1, this optical fiber 1 is provided with: a core 1a; an inner cladding layer 1b that is formed around the core 1a; and an outer cladding layer 1c that is formed around the inner cladding layer 1b.

The core 1a is made of silica glass in which Yb that is a rare earth element, Al, and fluorine (F) are added. A doping concentration of the Yb is preferably 0.8 wt % or more and 5.0 wt % or less. By adding the Yb to be of a high concentration, amplification of the optical fiber 1 per unit length can be high. On the other hand, by adding the Yb at the doping concentration of 5.0 wt % or less, clustering can be suppressed easily. Moreover, a doping concentration of the Al is preferably 2 wt % or more and 10 wt % or less. By adding the Al at the doping concentration of 2 wt % or more, the clustering of the Yb can be suppressed, and by adding the Al at the doping concentration of 10 wt % or less, crystallization of the Al can be prevented. Incidentally, the respective doping concentrations of the Yb and the Al are just illustration, and are not particularly limited.

The inner cladding layer 1b is made of silica glass in which potassium (K) that is an alkali metal is added. The outer cladding layer 1c is made of resin that has a lower refractive index than a refractive index of the inner cladding layer 1b. As the resin, for example, ultraviolet curable resin can be used. By composing the outer cladding layer 1c by the resin as described above, the outer cladding layer 1c can also function as a protector, which can omit the necessity of further providing a protective layer outside the outer cladding layer 1c, thereby making possible to decrease a diameter of the optical fiber 1. Moreover, by using the ultraviolet curable resin, a fiber drawing technique for ordinary optical fibers can be adopted, whereby the optical fiber 1 can be manufactured easily.

As illustrated by the refractive index profile in FIG. 1, due to an effect of the Yb and the Al to enhance a refractive index, a refractive index of the inner cladding layer 1b becomes lower than a refractive index of the core 1a. Moreover, for the outer cladding layer 1c, the resin having the lower refractive index than the refractive index of the inner cladding layer 1b is used. By the cross-sectional structure and the setting of the refractive index profile illustrated in FIG. 1, the optical fiber 1 realizes a double clad structure that can be applied to a double clad-type optical fiber laser.

Relative refractive-index difference of the core 1a with respect to the inner cladding layer 1b is decreased by the adding of the F, and ranges, for example, from 0.1% to 0.15%. By decreasing the relative refractive-index difference as described above, a mode field diameter (MFD) of the optical fiber 1 can be increased, whereby generation of an optical nonlinear effect in the core 1a can be suppressed.

This optical fiber 1 can be manufactured by, for example, two methods as described below. In the first method, a core preform made of silica glass in which Yb and Al are added is firstly inserted into an inner cladding layer-forming glass tube (a jacket tube) that is made of silica glass in which the K is added. Thereafter, the core preform and the jacket tube are heated so as to be integrated, thereby forming an optical fiber preform that is composed by the core preform and a preform inner cladding layer. Also, this optical fiber preform may be further inserted into a jacket tube, and the optical fiber preform and the jacket tube may be heated so as to be integrated. Subsequently, while drawing the optical fiber from the optical fiber preform, the resin to be the outer cladding layer 1c is formed therearound.

In the second method, silica glass fine particles are firstly deposited around the core preform that is made of the silica glass in which the Yb and the Al are added, thereby forming a porous layer. Thereafter, the K in a state of, for example, a liquid phase or a gas phase is added into the porous layer. Subsequently, the alkali metal-added porous layer is heated so as to be vitrified, thereby forming an optical fiber preform that is composed by the core preform and the preform inner cladding layer. Also, a porous layer may be further formed on this optical fiber preform and vitrified. Thereafter, while drawing the optical fiber from the optical fiber preform, the resin to be the outer cladding layer 1c is formed around the optical fiber.

In the conventional optical fiber with the double clad structure, pure silica glass is used for the inner cladding layer. Thus, as described above, in the processes for manufacturing the optical fiber preform and the optical fiber, a crack may be generated at an interface between the core preform and the preform inner cladding layer.

On the other hand, in the optical fiber 1 according to the first embodiment, the inner cladding layer 1b is made of the silica glass in which the K is added. Thus, viscosity of the jacket tube for forming the preform inner cladding layer, which is to be the inner cladding layer 1b, and viscosity of the porous layer are low, difference in viscosity between the core preform and the preform inner cladding layer is small. As a result, the generation of a crack at the interface between the core preform and the preform inner cladding layer is suppressed. Thereby, the productivity of the optical fiber 1 can be high, and the desired characteristics can be realized at high yield.

Also, since softening temperatures of the core preform and the preform inner cladding layer are decreased, a maximum value of a heating temperature in the process for manufacturing the optical fiber preform and the optical fiber can be decreased. As a result, the crystallization of the Al at the interface between the core preform and the preform inner cladding layer is suppressed. Thereby, an increase of transmission loss of laser light that is propagated in the core 1a and pumping light that is propagated in the core 1a and the inner cladding layer 1b, which is caused by the crystallized Al, is suppressed. Moreover, since the heating temperature at the time of drawing the optical fiber can be lower, the strain that remains in the optical fiber 1 can be reduced more. As a result, a manufacturing yield of the optical fiber 1 can be further enhanced, and the transmission loss of the pumping light that is propagated in the inner cladding layer 1b can be suppressed. In the case of applying the optical fiber 1 to a high-power optical fiber laser with an output of 1 W or higher, intensity of the pumping light is significantly high, for example, several hundred watts. If the transmission loss was large, the optical fiber might generate heat, however, the optical fiber 1 can be suppressed from such generation of heat.

Also, by adding K into the preform inner cladding layer, the difference in softening temperature and viscosity between the core preform and the preform inner cladding layer can be smaller than that in the case where the preform inner cladding layer is made of pure silica glass (see Japanese Patent Application Under PCT Laid-Open Under Kohyo No. 2010-526749). In particular, the difference in softening temperature and viscosity is preferably small enough not to cause the generation of a crack in the process for manufacturing the optical fiber preform and the optical fiber, and not to cause a strain in significant size to remain between the core 1a and the inner cladding layer 1b of the manufactured optical fiber 1. Accordingly, it is preferable to add the K in an amount that can realize such difference.

Also, it is preferable to add an alkali metal such as K to be of a high concentration in the preform inner cladding layer, because the refractive index of the inner cladding layer 1b can be increased, and the softening temperature thereof can be decreased.

For example, also by adding F into the preform inner cladding layer made of silica glass, the viscosity of the preform inner cladding layer can be decreased. However, since the adding of the F also decrease the refractive index of the preform inner cladding layer, the relative refractive-index difference of the core 1a with respect to the inner cladding layer 1b is increased. Thereby, the MFD of the optical fiber 1 becomes smaller. In the case of an optical fiber, such as the optical fiber 1, which can be preferably applied to a high-power optical fiber laser with an output of, for example, 1 W or higher, as the MFD becomes smaller, the optical nonlinear effect that is generated in the core becomes more significant, so that the adding of the F is not preferable.

Moreover, by adding germanium (Ge) into the preform inner cladding layer made of the silica glass, the refractive index of the preform inner cladding layer can be increased, and at the same time, the viscosity of the preform inner cladding layer can be decreased. However, since the Ge has diffusibility in silica glass, it is generally difficult to add the Ge into the preform inner cladding layer uniformly. Thus, a distribution may be generated in the refractive index of the manufactured inner cladding layer 1b, so that the adding of the Ge is not preferable for obtaining the desired refractive index profile and optical characteristics.

As described above, according to the first embodiment, the optical fiber 1 having the desired optical characteristics can be realized at high productivity.

Incidentally, in above-described the first embodiment, the K is added as the alkali metal into the inner cladding layer 1b, but lithium (Li) or sodium (Na) may be used, and two or more kinds among Li, Na and K may be coadded.

Moreover, in the first embodiment described above, the alkali metal is added into the inner cladding layer 1b, but an alkali earth metal may be added instead of the alkali metal. The alkali earth metals include calcium (Ca), strontium (Sr), barium (Ba) and the like, and among them, Ca is preferable. Also, two or more kinds among these alkali earth metals can be coadded.

Also, chlorine (Cl), phosphorus (P) and the like may be further added into the inner cladding layer 1b so as to enhance the refractive index thereof. The relative refractive-index difference of the inner cladding layer 1b with respect to pure silica glass may be 0% to 0.4%. Moreover, an alkali metal may be added into the core 1a so as to adjust the refractive index, the softening temperature, the viscosity or the like of the core 1a. Also, since a lifetime of a laser upper level of Yb³⁺ ions can be adjusted by adding the alkali metal into the core 1a, laser amplification characteristics of the optical fiber 1 can also be adjusted.

Moreover, the rare earth element to be added into the core 1a is not limited to the Yb, and Er or Tm may be added, or both of the Yb and the Er may be coadded.

Thereafter, the present invention will be described in more detail by examples and comparative examples. Incidentally, this invention is not limited by those examples.

### Comparative Example 1

By coadding Al to be of a concentration of 3.0 wt %, Yb to be of a concentration of 2.0 wt % and F by a VAD (vapor phase axial deposition) method, five core preforms having relative refractive-index difference of 0.1% with respect to pure silica glass were manufactured. Each of these core preforms was inserted into a jacket tube made of silica glass, and then, the core preform and the jacket tube were integrated by heating. As a result, with regard to three of the samples, optical fiber preforms with no external problem could be manufactured. However, in one of the samples, a crack was generated at an interface between the core preform and the jacket tube after cooling. Moreover, in another sample, the core preform was deformed, and eccentricity of the core preform with respect to the jacket tube occurred.

Subsequently, each of the above-described three optical fiber preforms with no external problem was further inserted into a jacket tube, and the process for integrating the optical fiber preform and the jacket tube were performed totally three times so as to form an preform inner cladding layer, thereby manufacturing an optical fiber preform with an outer diameter adjusted so that a core diameter of its core after being drawn might be 25 μm.

The thus manufactured three optical fiber preforms were drawn so as to manufacture optical fibers. In each of the optical fibers obtained from the optical fiber preforms, disorder occurred in a refractive index profile at the interface between the core and the inner cladding layer. A state of the interface between the core and the inner cladding layer of each optical fiber was checked, and a large strain was observed. Moreover, optical characteristics such as an MFD and a cutoff wavelength of each optical fiber were significantly different from their designed values, but this difference is considered as an influence caused by the disorder in the refractive index profile.

### Example 1

Four core preforms having the same characteristics as those of the core preforms in Comparative Example 1 were manufactured. Moreover, silica glass bars in which K⁺ ions were added were manufactured by the VAD method, and insides thereof were hollowed out along their central axes so as to manufacture jacket tubes. Each of the core preforms was inserted into the jacket tube, and the core preform and the jacket tube were integrated by heating. As a result, in each of the all four samples, no crack or the like was generated at an interface between the core preform and the jacket tube. Moreover, no uncircularization or eccentricity of the core preforms was observed after the integration.

Thereafter, each of the above-described four optical fiber preforms was further inserted into the jacket tube, and the process for integrating the optical fiber preform and the jacket tube were performed totally three times so as to form an preform inner cladding layer, thereby manufacturing an optical fiber preform with an outer diameter adjusted so that a core diameter of its core after being drawn might be 25 μm.

The thus manufactured three optical fiber preforms were drawn so as to manufacture optical fibers. In each of the optical fibers obtained from the optical fiber preforms, no disorder occurred in the refractive index profile at the interface between the core and the inner cladding layer. Also, a state of the interface between the core and the inner cladding layer of each optical fiber was checked, and a strain with only a small value was observed. A refractive index of each inner cladding layer was substantially equal to that of pure silica glass. Moreover, optical characteristics such as an MFD and a cutoff wavelength of each optical fiber were substantially equivalent to their designed values.

### Comparative Example 2

By coadding Al to be of a concentration of 3.5 wt %, Yb to be of a concentration of 2.2 wt % and F by the VAD method, four core preforms whose relative refractive-index difference with respect to pure silica glass was 0.15% were manufactured. Thereafter, using each of these core preforms as a target rod, fine particles made of pure silica glass were deposited on the core preform by the VAD method so as to form a porous layer. Thereafter, when the porous layer was vitrified at a temperature around a vitrification temperature of the pure silica glass, a crack was generated at an interface between the core preform and the vitrified porous layer in each sample, thus failing to manufacture any optical fiber preform. The reason for this was thought to be because difference in softening temperature between the core preform and the pure silica glass is large, which caused a large strain at the interface between the core preform and the vitrified porous layer in the vitrification process at such high temperature and cooling process thereafter. In addition, a state of the vitrified part where the crack is generated was checked, and crystallized Al existed on a surface of the core preform.

### Example 2

Five core preforms having the characteristics similar to those of the core preforms in Comparative Example 2 were manufactured. Thereafter, using each of these core preforms as a target rod, fine particles made of pure silica glass were deposited on the core preform by the VAD method so as to form a porous layer. Subsequently, each sample with the porous layer formed was impregnated in a KOH aqueous solution of a concentration of 1.0 wt % for one week so as to impregnate the porous layer with K, and each sample was subsequently dried for three days. Thereafter, the porous layer was vitrified, which could be performed at a temperature significantly lower than the temperature around the vitrification temperature of the pure silica glass. The reason for this was thought to be because the silica glass in which the alkali metal was added has a low glass transition temperature. Moreover, no crack was generated at an interface between the core preform and the vitrified porous layer. Further, the crystallized Al was not observed on a surface of the core preform.

Subsequently, a porous layer is further formed on each of the above-described five optical fiber preforms. The porous layer of each optical fiber preform was impregnated with K, which was dried and subsequently subjected to vitrification process totally three times so as to form a preform inner cladding layer, thereby manufacturing an optical fiber preform with an outer diameter adjusted so that a core diameter of its core after being drawn might be 20 μm.

The thus manufactured five optical fiber preforms were drawn under conditions equivalent to those in Example 1, thereby manufacturing optical fibers. In each of the optical fibers obtained from the optical fiber preforms, no disorder occurred in a refractive index profile at an interface between a core and an inner cladding layer. Moreover, a state of the interface between the core and the inner cladding layer was checked, and a strain with only a small value was observed. Also, both of transmission loss at a wavelength of 1150 nm and loss by OH groups at a wavelength of 1385 nm exhibited lower values than those in Example 1. Moreover, due to the adding of K, a refractive index of the inner cladding layer was higher than that of the pure silica glass by 0.1%.

### Example 3

Similarly to Example 1, a preform inner cladding layer was formed on a core preform so as to manufacture an optical fiber preform. Here, a silica glass bar in which K⁺ ions and Cl were coadded was manufactured by the VAD method, and an inside thereof was hollowed out along its central axis, which was used as a jacket tube. Then, similarly to Example 1, the optical fiber preform in which no crack or the like was generated at an interface between the core preform and the jacket tube could be manufactured. Moreover, the manufactured optical fiber preform was drawn under conditions equivalent to those in Example 1 so as to manufacture an optical fiber, no disorder occurred in a refractive index profile at an interface between a core and an inner cladding layer of the optical fiber. Moreover, due to the adding of the K and the Cl, a refractive index of the inner cladding layer was higher than that of the pure silica glass by 0.03%.

### Example 4

Similarly to Example 1, a preform inner cladding layer was formed on a core preform so as to manufacture an optical fiber preform. Here, a silica glass bar in which K⁺ ions and P were coadded was manufactured by the VAD method, and an inside thereof was hollowed out along its central axis, which was used as a jacket tube. Then, similarly to Example 1, the optical fiber preform in which no crack or the like was generated at an interface between the core preform and the jacket tube could be manufactured. Moreover, the manufactured optical fiber preform was drawn under conditions equivalent to those in Example 1 so as to manufacture an optical fiber, no disorder occurred in a refractive index profile at an interface between a core and an inner cladding layer of the optical fiber. Moreover, due to the adding of the K and the P, a refractive index of the inner cladding layer was higher than that of the pure silica glass by 0.1%.

### Example 5

A core preform in which Al to be of a concentration of 3.5 wt %, Yb to be of a concentration of 2.2 wt %, F and K⁺ ions were coadded by the VAD method was manufactured. Using this core preform, a preform inner cladding layer was formed so as to manufacture an optical fiber preform similarly to Example 1, and further, an optical fiber was manufactured by being drawn from the optical fiber preform. A heating temperature at the time of drawing the optical fiber could be lower than that in Example 1. Moreover, transmission loss of the obtained optical fiber was smaller than the transmission loss of the optical fiber in Example 1. The reason for this was thought to be because, by adding the K⁺ ions also into the core preform, a softening temperature was lowered.

### Example 6

Similarly to Example 1, a preform inner cladding layer was formed on a core preform so as to manufacture an optical fiber preform. Here, a silica glass bar in which Ca²⁺ ions that are an alkali earth metal were added instead of the K⁺ ions was manufactured by the VAD method, and an inside thereof was hollowed out along its central axis, which was used as a jacket tube. Then, similarly to Example 1, an optical fiber preform in which no crack or the like was generated at an interface between the core preform and the jacket tube could be manufactured. Moreover, an optical fiber was manufactured by being drawn from the manufactured optical fiber preform under conditions equivalent to those in Example 1, and no disorder occurred in a refractive index profile at an interface between a core and an inner cladding layer of the optical fiber.

### Second Embodiment

Next, an optical fiber laser according to a second embodiment of the present invention will be described. The optical fiber laser according to the second embodiment is provided with the optical fiber according to the first embodiment as an amplifying optical fiber.

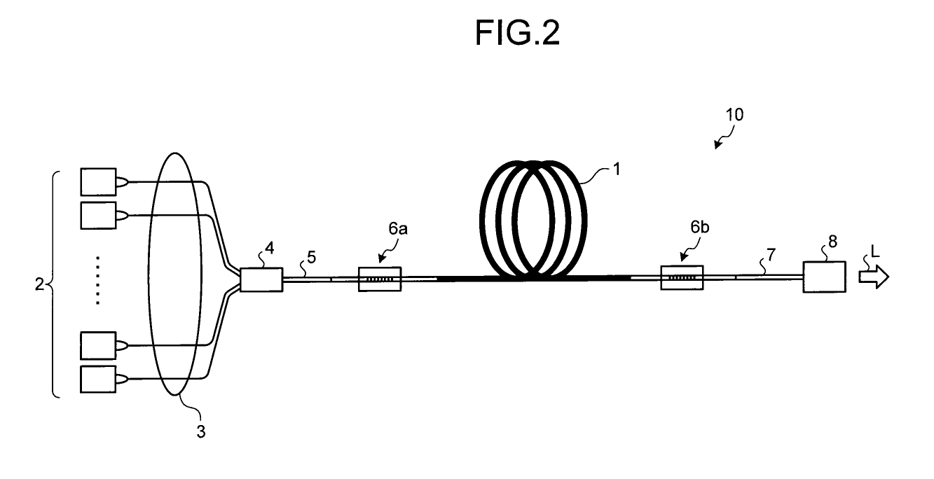

FIG. 2 is a schematic block diagram of the optical fiber laser according to the second embodiment. As illustrated in FIG. 2, an optical fiber laser 10 includes: plural semiconductor laser devices 2 that are pumping-light sources; plural multi-mode optical fibers 3 that guide waves of pumping light beams output from the semiconductor laser devices 2; a TFB (Tapered Fiber Bundle) 4 that bundles the pumping light beams whose waves are guided by the multi-mode optical fibers 3 and makes a double-clad optical fiber 5 to output the thus bundled pumping light beam; a double-clad optical fiber grating 6a that is connected sequentially with the double-clad optical fiber 5; an optical fiber 1; a double-clad optical fiber grating 6b; and an optical output connector 8 that is connected with a single-mode optical fiber 7.

A wavelength of the pumping light beam that is output from the semiconductor laser device 2 is around 915 nm. Moreover, the double-clad optical fiber grating 6a has: a reflection central wavelength of about 1060 nm; and reflectance of about 100% at the central wavelength and in a wavelength bandwidth of about 2 nm around the central wavelength, and transmits almost entire light at a wavelength of 915 nm. Further, the double-clad optical fiber grating 6b has: a central wavelength of about 1060 nm; reflectance of about 10% to about 30% at the central wavelength; and full width of about 0.1 nm at half maximum of a reflection wavelength bandwidth, and transmits almost entire light at the wavelength of 915 nm. Therefore, the double-clad optical fiber gratings 6a and 6b constitute an optical resonator with respect to light at a wavelength of 1084 nm.

In this optical fiber laser 10, when the semiconductor laser devices 2 output pumping light beams at a wavelength of around 915 nm, the multi-mode optical fibers 3 guide waves of the respective pumping light beams, and the TFB 4 bundles the respective pumping light beams whose waves are guided and outputs the thus bundled pumping light beam to the double-clad optical fiber 5. The double-clad optical fiber 5 propagates the bundled pumping light beam in multi-mode. Thereafter, the double-clad optical fiber grating 6a transmits the pumping light beam to reach the optical fiber 1.

The pumping light beam that reached the optical fiber 1 is propagated in a core 1a and an inner cladding layer 1b of the optical fiber 1 in multi-mode, and at the same time, the pumping light beam photoexcites Yb added into the core 1a so as to emit fluorescence that has a wavelength bandwidth including a wavelength of 1060 nm. This fluorescence is propagated in the core 1a in single-mode, and reciprocates in the optical resonator constituted by the double-clad optical fiber gratings 6a and 6b, and at the same time, the fluorescence is amplified by stimulated emission of the Yb ions, thereby emitting laser light at an emission wavelength of 1060 nm. The emitted laser light is output as laser light L from the optical output connector 8 via the double-clad optical fiber grating 6b and the single-mode optical fiber 7.

In this optical fiber laser 10, the optical fiber 1 according to the first embodiment is used as the amplifying optical fiber, and thus, the generation of the optical nonlinear effect can be suppressed.

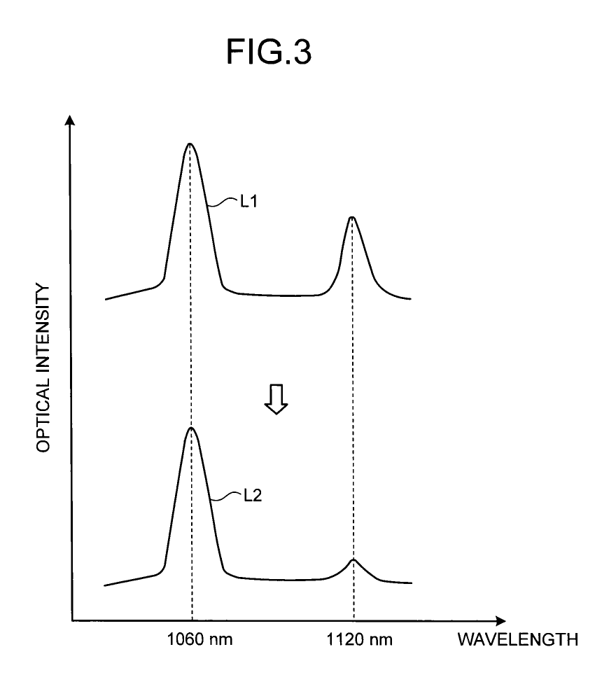

FIG. 3 is a schematic view of an output spectrum of the optical fiber laser. The spectrum L1 is an output light spectrum of an optical fiber laser using, as an amplifying optical fiber, the conventional optical fiber whose inner cladding layer is made of pure silica glass. As shown by the spectrum L1, as well as optical intensity of laser light at a wavelength of 1060 nm, optical intensity of excess light at a wavelength of 1120 nm which is generated by the optical nonlinear effect in the amplifying optical fiber is high in the conventional optical fiber laser. As a result, in the case of using the optical fiber laser, output optical intensity of the laser light at the wavelength of 1060 nm is necessary to be decreased to an extent that this excess light is not generated.

On the other hand, a spectrum L2 is an output light spectrum of the optical fiber laser 10 according to the second embodiment. As shown by the spectrum L2, since optical intensity of excess light at a wavelength of 1120 nm is lower than optical intensity of laser light at a wavelength of 1084 nm in the optical fiber laser 10, the optical fiber laser 10 can be used by setting the output optical intensity of the laser light at the wavelength of 1084 nm to be high.

Incidentally, the emission wavelength is 1060 nm in the second embodiment described above, but may be changed to another wavelength such as 1030 nm or 1084 nm by changing the reflection central wavelengths of the double-clad optical fiber gratings 6a and 6b. Moreover, the second embodiment provides the optical fiber laser that includes the optical resonator constituted by the double-clad optical fiber gratings 6a and 6b, but if the optical fiber laser 10 has a structure where the optical resonator is omitted and signal light is input into the optical fiber 1 for optical amplification, the optical fiber laser 10 can constitute an optical fiber amplifier.

According to an embodiment of the present invention, an optical fiber having desired optical characteristics is achievable with high productivity.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical fiber, comprising:
a core made of silica glass in which a rare earth element and aluminum have been added;
an inner cladding layer that is formed around the core, is made of silica glass in which at least any one of an alkali metal and an alkali earth metal has been added, and has a refractive index lower than a refractive index of the core; and
an outer cladding layer that is formed around the inner cladding layer and has a refractive index lower than the refractive index of the inner cladding layer.

2. The optical fiber according to claim 1, wherein the alkali metal or the alkali earth metal added in the inner cladding layer is at least any one of lithium, sodium, potassium, and calcium.

3. The optical fiber according to claim 1, wherein a doping concentration of the aluminum is 2 wt % or more and 10 wt % or less, the rare earth element is ytterbium, and a doping concentration of the ytterbium is 0.8 wt % or more.

4. The optical fiber according to claim 1, wherein a relative refractive-index difference of the core with respect to the inner cladding layer is 0.1% to 0.15%.

5. The optical fiber according to claim 1, wherein the core is added with fluorine.

6. The optical fiber according to claim 1, wherein the outer cladding layer is made of a resin.

7. The optical fiber according to claim 1, wherein a relative refractive-index difference of the inner cladding layer with respect to pure silica glass is 0% to 0.4%.

8. The optical fiber according to claim 1, wherein the inner cladding layer is added with chlorine or phosphorus.

9. The optical fiber according to claim 1, wherein the core is doped with an alkali metal.

10. An optical fiber laser comprising the optical fiber according to claim 1 as an amplifying optical fiber.

11. An optical fiber amplifier comprising the optical fiber according to claim 1 as an amplifying optical fiber.

12. A method of manufacturing an optical fiber, comprising:
inserting a core preform made of silica glass in which a rare earth element and aluminum have been added, into an inner-cladding-layer-forming glass tube that is made of silica glass in which at least any one of an alkali metal and an alkali earth metal has been added and has a refractive index lower than a refractive index of the core preform; and
heating and integrating the core preform and the inner-cladding-layer-forming glass tube.

13. The method of manufacturing an optical fiber according to claim 12, wherein the alkali metal or the alkali earth metal is at least any one of lithium, sodium, potassium, and calcium.

14. The method of manufacturing an optical fiber according to claim 12, wherein a doping concentration of the aluminum is 2 wt % or more and 10 wt % or less, the rare earth element is ytterbium, and a doping concentration of the ytterbium is 0.8 wt % or more.

15. A method of manufacturing an optical fiber, comprising:
forming a porous layer by depositing silica glass fine particles around a core preform made of silica glass in which a rare earth element and aluminum have been added;
adding at least any one of an alkali metal and an alkali earth metal into the porous layer; and
heating and vitrifying the porous layer that has been doped with the at least any one of an alkali metal and an alkali earth metal.

16. The method of manufacturing an optical fiber according to claim 15, wherein the alkali metal or the alkali earth metal is at least any one of lithium, sodium, potassium, and calcium.

17. The method of manufacturing an optical fiber according to claim 15, wherein a doping concentration of the aluminum is 2 wt % or more and 10 wt % or less, the rare earth element is ytterbium, and a doping concentration of the ytterbium is 0.8 wt % or more.
